(19) United States
(12) Patent Application Publication
(10) Pub. No.: US 2024/0020547 A1
(43) Pub. Date: Jan. 18, 2024

(54) HARMONIZED QUALITY (HQ)

(71) Applicant: IQVIA Inc., Durham, NC (US)

(72) Inventors: Lars Jonas Mikael Renstroem, Uppsala (SE); Michael Charles Kalavsky, Carrboro, NC (US); Sumanta Sharma, Holy Springs, NC (US)

(21) Appl. No.: 17/864,879

(22) Filed: Jul. 14, 2022

(51) Int. Cl. G06N 5/02; G06Q 30/02

(52) U.S. Cl. CPC G06N 5/022; G06Q 30/0201; G06Q 30/0204

(57) ABSTRACT

A method comprises training an artificial intelligence (AI)/machine-learning (ML) system to identify one or more issues at sites, studies, or customer portfolios. The method also includes applying the trained AI/ML system to identify one or more issues at the sites, studies, or customer portfolios. The method also includes identifying one or more risks from the one or more identified issues at the sites, studies, or customer portfolios by one or more clinical leads. The one or more clinical leads identify a cause for the one or more identified risks among statistical composite risks, investigator risks, monitoring risks, and/or recruitment risks. The method also includes identifying mitigation actions for the one or more identified risks by using insights from past performance. The method also includes applying the mitigation actions onto the one or more identified risks.

### FIELD OF INVENTION

Embodiments disclosed herein relate, in general, to a Harmonized Quality (HQ) system for identifying one or more risks within, and identifying and providing appropriate mitigation actions to address those risks.

### BACKGROUND

There have historically been significant portions of findings from audits/inspections that are related to clinical oversight. In many instances, a standard interface for clinical oversight roles such as clinical leads were not available. The capacity to aggregate data and results across studies has not been available.

May types of clinical oversight or site risk identification tools are within the industry. An RDS navigator was used in the past. The RDS navigator had a lot of inherent limitations in design and logic and was limited in scope. Another past solution was a centralized monitoring platform. However, the centralized monitoring platform focused on looking at data only on a study-by-study basis.

Current systems do not involve an efficiency assessment. As such, there are no current systems that determine the amount of time to get to site compliance. There are also no known actions in relation to clinical oversight teams.

Other drawbacks of most current systems are that they focus on risks and data at study site level. In other words, there is only data from sites in one study at a time. In addition, there is no holistic approach in which data multiple studies at a time can be obtained. The current approaches or systems fall short in relation to the breadth of data reviewed and of customization capabilities. There is also no type of mitigation action analysis for any identified issues.

Accordingly, there is a need for a system that enables a breadth of data to be analyzed from multiple studies including whole portfolios. Moreover, a more holistic approach is needed to evaluate risks using more operational risk categories. The aggregation of data customization capabilities is also required. Mitigation actions and the efficiency of mitigation actions need to be identified to facilitate the handling of one or more risks that occur from multiple studies and/or sites.

### SUMMARY

Embodiments of the present invention provide a computing device implemented method. The method includes training an artificial intelligence/machine learning system to identify one or more issues at sites, studies, or customer portfolios. The method also includes applying the trained artificial intelligence/machine learning system to identify the one or more issues at the sites, studies or customer portfolios. Further, the method includes identifying one or more risks from the one or more identified issues at the sites, studies, or customer portfolios by one or more clinical leads. The one or more clinical leads identify a cause for the one or more identified risks among statistical composite risks, investigator risks, monitoring risks, audit/inspection likelihood, and/or recruitment risks. In addition, the method includes identifying mitigation actions for the one or more identified risks by using insights from past performance to identify the mitigation actions that will address the one or more identified risks. The method also includes applying the mitigation actions onto the one or more identified risks from the sites, studies and/or customer portfolios.

The method further includes providing snapshots of issues at countries, regions, and/or investigators in real-time.

The method also includes identifying measurement data and/or metrics from the one or more identified risks of the sites, studies, and/or customer portfolios.

Further, embodiments of the present invention may provide a computer program product comprising a tangible storage medium encoded with processor-readable instructions that can be executed by one or more processors. The computer program product can train an artificial intelligence/machine learning system to identify one or more issues at sites, studies, or customer portfolios. The computer program product can also apply the trained artificial intelligence/machine learning system to identify the one or more issues at sites, studies or customer portfolios. The computer program product can also identify one or more risks from the one or more identified issues at the sites, studies, or customer portfolios by one or more clinical leads. The one or more clinical leads identify a cause for the one or more identified risks among statistical composite risks, investigator risks, monitoring risks, and/or recruitment risks. Further, the computer program product can identify mitigation actions for the one or more identified risks by using insights from past performance to identify the mitigation actions that will address the one or more identified risks. Further, the computer program product can apply the mitigation actions onto the one or more identified risks from the sites, studies and/or customer portfolios.

Further, the computer program product can enable data to be aggregated by study, customer, study indication, and/or region.

Further, the snapshots of the issues at the sites, studies, or customer portfolios provide a real-time overview of operational performance.

A computing system is connected to a network. The system can include one or more processors. The one or more processors are configured to train an artificial intelligence/machine learning system to identify one or more issues at sites, studies, or customer portfolios. The one or more processors are also configured to apply the trained artificial intelligence/machine learning system to identify the one or more issues at sites, studies or customer portfolios. Further, the one or more processors are configured to identify one or more risks from the one or more identified issues at the sites, studies, or customer portfolios by one or more clinical leads. The one or more clinical leads identify a cause for the one or more identified risks among statistical composite risks, investigator risks, monitoring risks, and/or recruitment risks. The one or more processors are also configured to identify mitigation actions for the one or more identified risks by using insights from past performance to identify the mitigation actions that will address the one or more identified risks. Further, the one or more processors are configured to apply the mitigation actions onto the one or more identified risks from the sites, studies and/or customer portfolios.

The system identifies an effectiveness of the identified mitigation actions.

The system includes matching the identified mitigation actions with the one or more risks based on an effectiveness of the identified mitigation actions.

These and other advantages will be apparent from the present application of the embodiments described herein.

The preceding is a simplified summary to provide an understanding of some embodiments of the present invention. This summary is neither an extensive nor an exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a system according to an embodiment of the present invention;

FIG. 2 illustrates another illustration of the system according to an embodiment of the present invention;

FIG. 3 depicts a further illustration of the system according to an embodiment of the present invention;

FIG. 4 illustrates features according to an embodiment of the present invention;

FIG. 5 illustrates additional features according to an embodiment of the present invention; and

FIG. 6 illustrates a flowchart according to an embodiment of the present invention.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “dataset” is used broadly to refer to any data or collection of data, inclusive of but not limited to structured data (including tabular data or data encoded in JSON or other formats and so on), unstructured data (including documents, reports, summaries and so on), partial or subset data, incremental data, pooled data, simulated data, synthetic data, or any combination or derivation thereof. Certain examples are depicted or described herein in exemplary sense without limiting the present disclosure to other forms of data or collection of data.

The present invention involves a one-stop shop and holistic approach. The harmonized quality (HQ) aggregates information from a multitude of sources to facility clinical operational oversight by highlighting site and study level risks using advanced algorithms and artificial intelligence/machine-learning (AI/ML). In addition to creating an interface to identify specific operational risks, the HQ allows for an extremely robust source of many different operational metrics. Clinical leads, centralized monitoring leads and quality managers will be used to make a “one stop shop” for clinical oversight and operational decision-making.

The HQ uses a more holistic approach and not only one study at a time or one subset of risks. The HQ takes data into consideration that covers key risk indicators (KRI) that cover data flow metrics. Other risks that the HQ covers also include monitoring risks, investigator risks, audit/inspection likelihood and recruitment risks. The HQ also focuses on senior oversight roles and customer account mangers to use new ways to aggregate data onto just on a site level, but also in relation to study, country, customer, region, global, indication, investigator, study phase level, and other options and variations. As such, there is an unparalleled and near real-time overview of operational performance while also allowing to review trends over time. Long-term benefits of uses include the data intelligence generated that will allow for detailed and AI/ML assisted decision workflow for clinical teams. The investigator level will also provide valuable insights when selection sites for new trials or to see specific risks for certain types of trials. The types of trials can be mitigated up front as early as protocol design to have better trials overall.

The HQ will also include the creation of workflows relating to clinical oversight and risk mitigation. As a result, AI/ML assisted assessment of the effectiveness of the mitigation actions will occur. In other words, how effective a mitigation action will be that can bring the site to compliance.

In relation to the mitigation actions, the intent will be to use the AI/ML within the HQ to match the mitigation actions, and their effectiveness, with the site profiles/risk profiles to make the decision tree for the clinical teams faster and more effective. The decision tree for the clinical teams can become faster and more effective by suggesting actions to be taken and allow for the clinical teams to focus their time on items that are too complicated for the AI/ML algorithm(s) to try to solve.

The more the HQ is being used, the faster the AI/ML will identify what mitigation action will work effectively in each risk situation. The level of insights generated will simply increase to provide better and better recommendations for the identified risks. Further, the HQ will be able to recommend different actions or mitigation actions depending on what mitigation action would work in a specific country or region where a local variation to working coulter can lead to differences in mitigation efficiency.

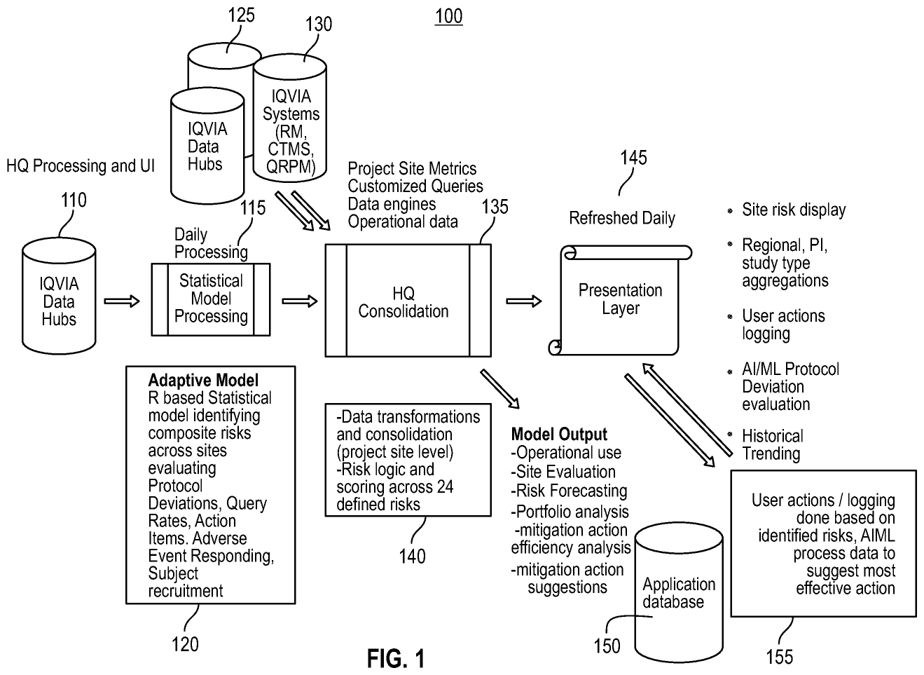

FIG. 1 illustrates a harmonized quality (HQ) system (system) 100 that identifies risks in various sites and areas as data processing is occurring. In response to those risks, the system 100 will identify mitigation actions, wherein the system 100 will identify the mitigation actions based on past history of the mitigation. The system 100 will also determine the effectiveness of the mitigation actions based on the prior use and past history of the mitigation actions. Further, the system 100 will match the mitigation actions with the appropriate risk identified to mitigation the risk accordingly.

Referring to FIG. 1, a data hub 110 provides input data for processing. A statistical model processor 115 will process the data. As the data is processing, a series of risks can be identified. An adaptive model 120 will identify composite risks across various sites. The risks can include protocol deviations. Other identified risks can include deviations in query rates and action items. Further risks can also include adverse event reporting and deviations or abnormal occurrences with subject recruitment. As the risks are identified, the statistical model processor 115 can send the processed data to an HQ consolidator 135. In addition, another data hub 125 and a data system 130 will send data to the HQ consolidator 135. The data will include project site metrics, customized queries, information on data engines, and operational data. The HQ consolidator 135 can consolidate the data received from the statistical model processor 115, data hub 125, and the data system 130. The HQ consolidator 135 will consolidate the received data so that data transformation and consolidation occurs at the project site level. As the received data is being consolidated, risk logic and scoring across at least twenty-four defined risks are occurred. In other words. As data is being consolidated from the statistical model processor 115, data hub 125, and data system 130, risks are defined and scored.

In FIG. 1, the HQ consolidator 135 will include a model output that includes operational use and site evaluation. Risk forecasting is also part of the model output. The risk forecasting can include the effect of risks on the output data. The model output can also include portfolio analysis based on the identified risks. Moreover, due to the risks that are involve, the model output will also include mitigation action efficiency analysis. The mitigation efficiency analysis includes identify the mitigation actions based on past history which proved to be most efficient at addressing the identified risks. When the mitigation actions that have been identified as being most effective at handling or addressing the risks, the mitigation action suggestions can be made. The mitigation actions suggestions will include matching the mitigation actions to the identified risks. The mitigation actions would be matched to the identified risks based on the past effectiveness of the mitigation actions to the identified risks. As such, the mitigation actions identified to be the most effective to the identified risks would be suggested to be matched to the identified risks. The model output form the HQ consolidator 135 will be placed in an application database 150.

In FIG. 1, additional output from the HQ consolidator 135 will be placed into a presentation layer 145. The output from the presentation layer 145 will be refreshed daily in intermittent intervals throughout the course of a day. The presentation output on the presentation layer 145 will include user actions 155. The user actions 155 will also include user log in actions done based on the identified risks. The AI/ML algorithm within the system 100 will process the data to identify the most effective mitigation action. As mentioned above, the most effective mitigation actions will be the mitigation actions identified by past history that were shown to be most effective in addressing the identified risks. The user actions 155 and mitigation actions will be shown in the presentation layer 145.

Referring to FIG. 1, the presentation layer 145 will display site risks. The presentation layer 145 will also display regional study type aggregations. Further, the user actions of logging in and data input will be displayed. Moreover the AI/ML protocol deviation evaluation of the data will also be shown. In addition, the historical trending of the mitigation actions with the identified risks will also be displayed.

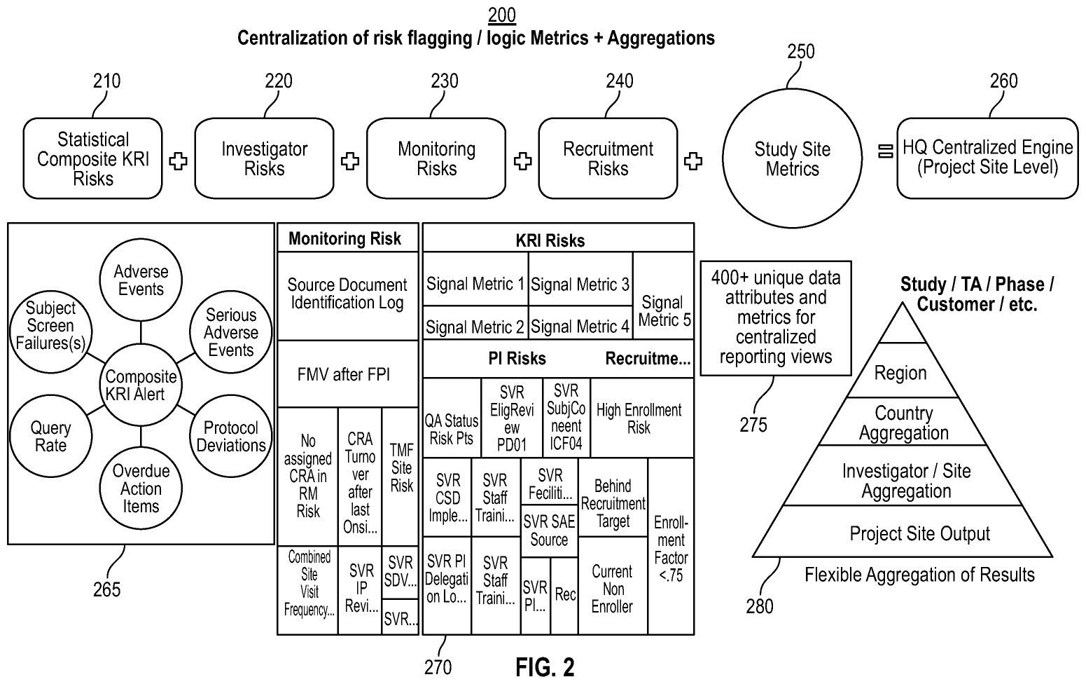

With respect to FIG. 2, a centralization 200 of the risks is identified in the system of FIG. 1 is illustrated further. The centralization 200 includes statistical composite key risk indicator (KRI) risks 210, investigator risks 220, monitoring risks 230, and recruitment risks 240. In addition, study site metrics 250 are included. The addition or summation of the statistical composite KRI risks 210, investigator risks 220, monitoring risks 230, recruitment risks 240, and study site metrics 250 can equal the HQ centralized engine 260 at the project site level.

Referring to FIG. 2, some of the of the statistical composite KRI risks 210 are illustrated in a risk chart 265. In the risk chart 265, a composite KRI alert is shown. The other risks illustrated in the risk chart 265 include subject screen failures, adverse events, serious adverse events, protocol deviations, overdue action items and query rate. As such, for the statistical composite KRI risks 210, the adverse (serious) adverse events, protocol deviations, and overdue action times are some of the important statistical composite KRI risks 210 in addition to query rate and subject screen failures. Other statistical composite RKI risks 210 can include signal metric 1, 2, 3, 4, and 5 shown in the risks table 270.

In FIG. 2, investigator risks 220 can include valuable insights in relation to selecting sites for new trials. The investigator risks can also indicate specific risks for certain types of trials that can be mitigation up front as early as protocol design. Accordingly, better trials can occur as result.

With respect to FIG. 2, the monitoring risks 230 are shown in the risk table 270. The monitoring risks 230 will include source document identification log, wherein identifying the source of the data cannot be obtained or difficult to identify. Other monitoring risks 230 can include a first monitoring visit (FMV) after a first patient in (FPI), an unassigned clinical research associate (CRA) in a risk management (RM) risk, CRA turnover after last onsite visit, trial master file (TMF) site risks, combined site visit frequency, site visit report (SVR) IP Revision, and SVR/source data review (SDR) risks.

Referring to FIG. 2, the recruitment risks 240 are also shown in the risks table 270. Some of the recruitment risks include high enrollment risk and being behind a recruitment target. Additional recruitment risks 240 include having current non-enrollment numbers or having an enrollment factor less than 75. The recruitment risks 240 are identified with the statistical composite KRI risks 210, investigator risks 220, and monitoring risks 230 onto the study site metrics 250.

In FIG. 2, the study site metrics 250 can include the unique data attributes 275 for the risks that are identified among the statistical composite KRI risks 210, investigator risks 220, monitoring risks 230, and recruitment risks 240. The unique data attributes 275 can be at least four hundred attributes. The unique data attributes 275 can include centralized reporting views for the identified risks. As such, the study site metrics 250 including the unique data attributes 275 can be summed or aggregated with the statistical composite KRI risks 210, investigator risks 220, monitoring risks 230, and recruitment risks 240. The study site metrics 250 include metrics for the centralized reporting views.

With respect to FIG. 2, the aggregation of results 280 are illustrated. Moreover, the aggregation of results 280 include results at the project site output, investigator/site aggregation, country aggregation, and by region. In other words, results at each site visited are aggregated. Further, the aggregation for each investigation is included at each site is included. The risks and data for each region and each country are aggregated.

In FIG. 2, the HQ centralized engine 260 receives the aggregated data from the aggregation of results 280, the statistical composite KRI risks 210, investigator risks 220, monitoring risks 230, and recruitment risks 240 and also the study site metrics 250. Accordingly, in summary, the different risks are identified per site, per region, and per country, and the types of risks are also identified. The metrics at each site are also identified. The different type of identified risks are identified and aggregated with the metrics to get to the HQ centralized engine 260.

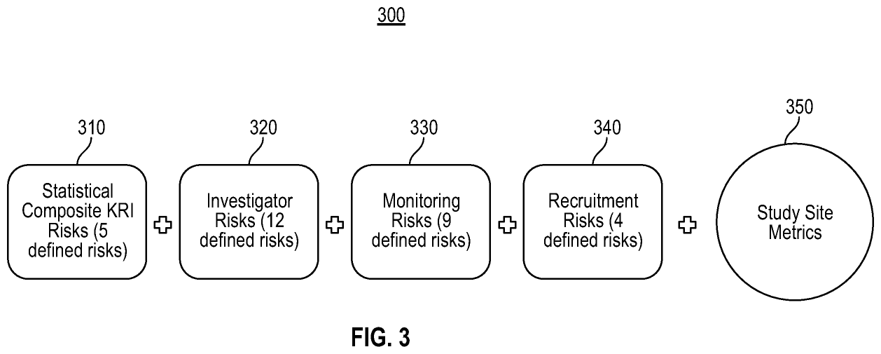

Referring to FIG. 3, the system 300 illustrating the risks are shown apart from the identified risks. The statistical composite key risk indicator (KRI) risks 310 are shown. The statistical composite KRI risks 310 will include at least five defined risks. The five defined risks include adverse events, including serious adverse events, protocol deviations, overdue action items, and subject screen failure. Signal metric 1 thru signal metric 5 can also be amount the statistical composite KRI risks 310.

In FIG. 3, the investigator risks 320 are also illustrated. The investigator risks 320 can include up to twelve defined risks. Moreover, the investigator risks 320 can also include QA status risk points, SRV eligibility review, and also a SVR subject component. The investigator risks 320 can further include SVR implementation, SVR training, SVR implementation, SVR staff training, and SVR Delegation. Moreover, most of the SVR risks can be among the identified investigator risks 320. The investigator risks 320 can also include over or under-enrollment as well.

With respect to FIG. 3, the monitoring risks 330 are illustrated. The monitoring risks 330 can include up to, and exceeding, in some embodiments, nine or more risks. Some ii of the monitoring risks include source document identification log, and also FMV after FPI as in FIG. 2. Other monitoring risks 330 can include non-assigned CRA in an RM risk and CRA turnover after a last onsite visit. In addition, other monitoring risks 330 can further include TMF site risks, combined site visit frequency, and also SVR IP revisions and other SVR risks as well.

Referring to FIG. 3, recruitment risks 340 are also illustrated in the system 300 of risks. The recruitment risks can include four or more risks in one or more embodiments of the invention. Some of the recruitment risks 340 can include high enrollment or over-enrollment. Further, additional recruitment risks 340 can include being behind a recruitment target were fewer enroll than what was originally expected. In addition, recruitment risks 340 can include current non-enrollment and/or an enrollment factor less than seventy-five percent. As such, the recruitment risks 340 can also relate to over-enrollment or having lesser enrollment than expected. The enrollment in relation to over and under enrollment can also be included under the investigator risks 320 described above.

In relation to FIG. 3, the study site metrics 350 are also illustrated. The study site metrics 350 will include unique data attributes. The study site metrics 350 can also include the metrics that are identified with the statistical composite KRI risks 310 that involve signal metric 1 thru signal metric 5. The study site metrics 350 can further include centralized reporting views. The centralized reporting views can include data on the statistical composite KRI risks 310, investigator risks 320, monitoring risks 330, and recruitment risks 340.

Overall, in FIG. 3, the number of risks in relation to the statistical composite KRI risks 310, investigator risks 320, monitoring risks 330, and recruitment risks 340 can be identified. The study site metrics 350 that can include data attributes on the identified risks can also be identified. The identified statistical composite KRI risks 310, investigator risks 320, monitoring risks 330, and recruitment risks 340 can be aggregated with the study site metrics 350 to obtain the HQ centralized engine. As such, the HQ centralized engine at the project site level can be identified from the aggregation of the identified risks and the study site metrics accordingly.

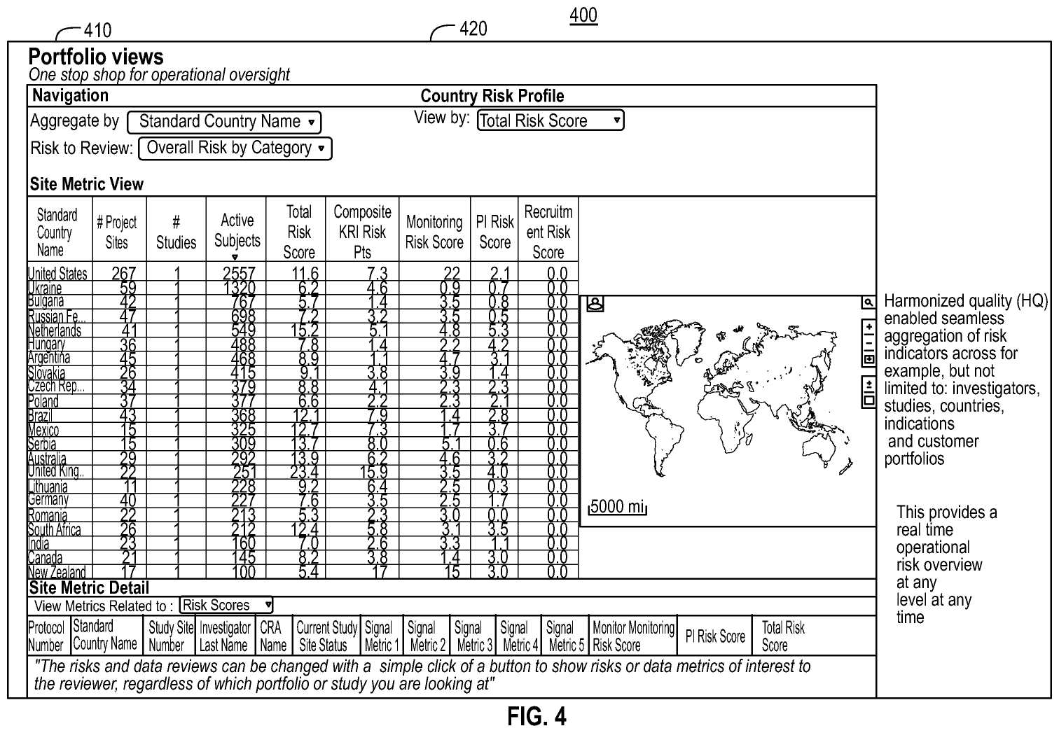

Referring to FIG. 4, the HQ system 400 is shown of countries with portfolio views 410 and a country risk profiles 420. The system 400 illustrates a chart with a list of project sites, studies, active studies, active subjects, and total risks score is shown. Further, the system 400 also includes a chart of the total risk score for each country and a composite KRI risk score and a monitoring risk score. In addition, the system includes a chart of the investigator or PI risk score and the recruitment risk score as well. The study site metrics are also illustrated as well.

In FIG. 4, a list of countries from the United States to New Zealand are shown in the chart. For each country, a number of project sites are shown. Each country can have one study done for each of the project sites. A key difference to note is the amount of active subjects in each country. For instance, a country such as the United States will have more active subjects than other countries. Ukraine is another country that will tend to have more active subjects. Each of the listed countries can have a total risk score depending on the risks identified at the project sites. Further, each of the countries can have composite KRI risk points that are based on the KRI (key risk indicators mentioned above) that are identified in the studies of the active subjects at the project sites. The composite KRI risk points can also include the signal metric 1 thru signal metric 5. The United Kingdom is likely to have more KRI risks than the other countries within the country risk profiles 420. The monitoring risk score for each country can include the scoring based on the nine monitoring risks described in FIG. 3. The United States in several embodiments will entail more monitoring risks than the other countries. The PI or investigator risks for each country that can be associated among the monitoring risks or investigator risks as described in FIG. 3. The recruitment risk score is shown, wherein each country does not have any of the risk factors to obtain a recruitment risk score.

Referring to FIG. 4, the risks and data reviews shown in the portfolio views 410 and country risk profile 420 can be changed with a user click to show the other risks or data metrics that the users desires to see regardless of which portfolio views 410 the user is viewing. In other words, the user can click on a link to the country of interest to see the data of that country, or to the particular risk score of interest. The user can view a reduced or enlarged portion of the portfolio view 410 as well. Harmonized quality or HQ will enable seamless aggregation of risk indicators. The risk indicators can include, but are not limited to, investigators, studies, countries, other indications, and customer portfolios. As such, the system 400 with the portfolio views 410 and country risk profiles 420 provide a real-time operational risk overview at any level at any time.

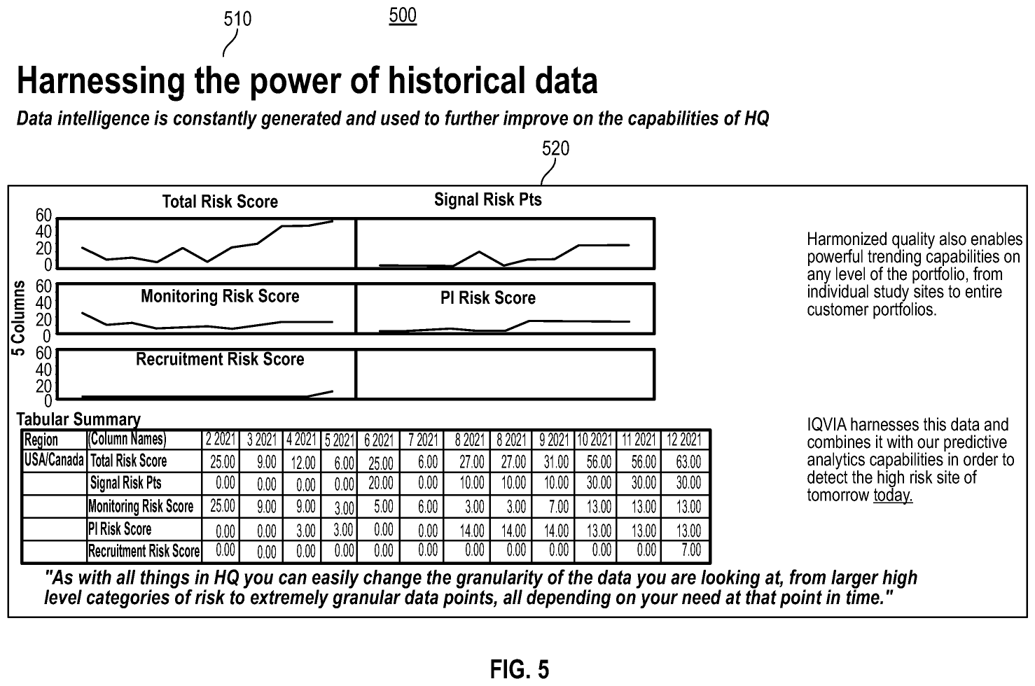

In FIG. 5, an HQ system 500 showing historical data 510 and risk score table 520 are illustrated. The historical data 510 can include the risks scores that have been part of each country in the past. The past historical data 510 can be used to anticipate or predict the future risk scores for monitoring risks, recruitment risks, investigator risks, etc.

Still referring to FIG. 5, a risk score table 520 is shown. Within the risk score table 520, a total risk score is shown. The total risk score will include the range of monitoring risk score and the range of a recruitment risk score. The range of the PI risk score is also shown, wherein the PI risk score can be associated with the investigator risks or in some instances, the monitoring risks. The range of signal risk points is also illustrated. With the risk score table 520, a tabular summary is also shown. The tabular summary will include the region such as the country involved. The column names within the tabular summary will include a total risk score based on the signal risk points, monitoring risk score, PI (investigator) risk score, and recruitment risk score.

With respect to FIG. 5, the benefits of HQ are further illustrated. The granularity of the data can be easily adjusted based on the user desiring to view a different or particular part of the risk scores 520. The user can view larger high-level categories of risk to extremely granular data points. The user may want to view the entire table of risk scores 520, or only focus on the monitoring risk score. As such, the user can adjust his/her view to view what portion of the risk score table 520 that the user wants to view.

In FIG. 5, the HQ enables power trending capabilities on any level of the portfolio. Individual study sites can be viewed. In addition, entire customer portfolios can be viewed. Using the past historical data 510, the predictive analytics of the AI/ML based HQ is trained with the predictive and analytical capability to detect the high risks of the future in the present timeframe. Moreover, the predictive analysis of the HQ can identify the mitigation actions from the past that were successful on the predicted risks, and then match the mitigation actions with the predicted risks accordingly.

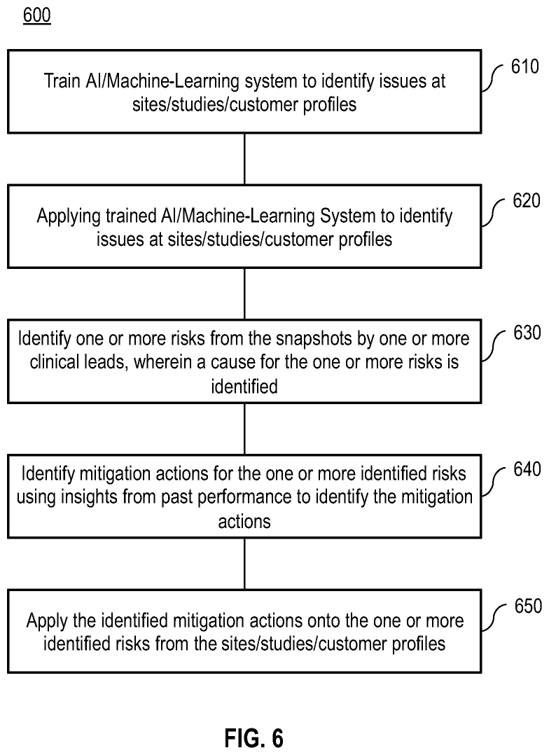

Referring to FIG. 6, a flow chart or method 600 illustrating the HQ is described in detail. The method 600 includes how the AI/ML trained HQ is used to identify issues/risks at various sites and or studies and pair those risks with the appropriate mitigation actions.

In FIG. 6, at step 610, AI/ML HQ system is trained to identify issues at sites. The HQ can also be trained to identify issues at one or more studies and or customer profiles. As data is being processed and transferred from data hubs to the HQ consolidator to be placed on the presentation layer, the HQ system will identify any issues that are appearing. The risks can be statistical composite KRI risks, monitoring risks, investigator risks, and recruitment risks.

Referring to FIG. 6, at step 620, the AI/ML system is trained to identify issues at sites, studies, or customer profiles. The issues can include one or more risks at the sites, studies, or customer profiles as data is passed from the data hubs onto the statistical model processor and the HQ consolidator. The system will use the trained AI/ML system to identify the risks at the sites, studies, or customer profiles.

In FIG. 6, at step 630, one or more risks are identified from the snapshots. One or more clinical leads can identify the one or risks from the snapshots. As the data hubs pass data from data hubs to the statistical model processor, and then the HQ consolidator, the risks can be identified. Composite risks across sites evaluation protocol deviations, query rates, and action items are identified. Adverse event responding and subject recruitment are identified. Risk logic and scoring across up twenty-four or more defined risks occurs. The risks can include the statistical composite KRI risks, monitoring risks, investigator risks, and recruitment risks.

Referring to FIG. 6, at step 640, mitigation actions to apply to the one or more identified risks. The HQ system identifies the mitigation actions from past history. The mitigation actions that were effective in the past at addressing the identified risks are identified to address the identified risks at the sites, studies, or customer profiles.

In FIG. 6, at step 650, the identified mitigation actions are applied onto the identified risks. The identified mitigation actions are applied onto the identified risks from the sites, studies, and/or customer profiles. The past performance of the mitigation actions will increase the likelihood that the applied mitigation actions will reduce and/or mitigate the identified risks.

In summary, the HQ system includes an AI/ML system that is trained to identify issues or risks at sites, studies, or customer profiles. The risks can be identified at sites, studies, and/or customer profiles. The risks can be identified as the data from data hubs is passed onto a statistical model processor, and then onto an HQ consolidator. The AI/ML system will be trained to identify the one or more risks. The risks are thereby identified by applying the trained AI/ML system. One or more mitigation actions are identified to address the identified risks. Past history of the mitigations are used to identify the efficiency of the mitigation actions. The past history will reveal how effective the mitigation actions were when applied onto the identified risks. The mitigation actions with a high level of past efficiency on the risks are then suggested. The suggested mitigation actions are then applied on the identified risks to reduce and/or mitigation the risks accordingly.

The risks identified can include statistical composite KRI risks. The statistical composite KRI risks can include adverse events, overdue action items, and protocol deviations. The other risks can include investigator risks, wherein the investigator risks can include Site Visit Report (SVR) risks in relation to staff training, implementation, and delegation on location. Monitoring risks are also includes such as source document identification and combined site frequency. Recruitment risks such as high enrollment risk or behind a recruitment target can also be included.

The various risks are summed or aggregated along with the study site metrics to make up the HQ system. The statistical composite KRI risks can have up to five risks. The investigator risks can include up to twelve risks. The monitoring risks can include up to nine defined risks. The recruitment risks can include up to four defined risks. The study site metrics can include at least four hundred unique data attributes and metrics for centralized reporting views. The aggregation of the statistical composite (KRI) risks, investigator risks, monitoring risks, recruitment risks, and study site metrics can lead to the HQ system or centralized engine at the project site level.

Each of the countries can include portfolio views and a country risk profile. Countries such as the United States and the Ukraine can include more subjects. The total risk score for each country is shown. The scores for the composite KRI risks, monitoring risks, investigator or PI risks, and recruitment risks are also shown. The HQ enables seamless aggregation of risk indicators such as with investigators, studies, countries, indications, and customer portfolios. There is also a real-time operational risk overview at any level at any time. Moreover, the risks and data reviews can be changed by a click of a button by a user to show the risks or data metrics of interest to the user.

The power of historical data can be harnessed. Data intelligence will be constantly generated and used to further improve capabilities of the HQ system. The graph and table of the total risk score, signal risk points, and monitoring risk score, investigator risk score, and recruitment risk score are shown. The HQ enables powerful trending capabilities from individual study sites to entire customer portfolios. The data is harnessed and combined with predictive analytics capabilities to detect the risk site before it occurs. With the HQ, the granularity of the data can be changed from larger high-level categories of risk to extremely granular data points, depending on the needs of the users.

The AI/ML based HQ can be trained and applied to identify issues that include, but are not limited to, sites, studies, and customer profiles. One or more risks can be identified from the snapshots by one or more clinical leads. A cause for the one or risks is identified. Mitigation actions for the one or more risks are identified using insights from past performance to identify the mitigation actions. The identified mitigation actions will then be applied onto the one or more identified risks. As a result, the operational efficiency of the computing system or systems is improved. The computing systems or systems are able to predict what mitigation actions to apply based on what occur in the past.

According to an embodiment of the present invention, a laptop computer, a desktop computer, a smart device, a smart watch, a smart glass, a personal digital assistant (PDA), and so forth can be utilized. Embodiments of the present invention are intended to include or otherwise cover any type of the user device 102, including known, related art, and/or later developed

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure.

The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed.

Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

What is claimed is:

1. A computing device implemented method, the method comprising:
training an artificial intelligence/machine learning system to identify one or more issues at sites, studies, or customer portfolios;
applying the trained artificial intelligence/machine learning system to identify the one or more issues at the sites, studies or customer portfolios;
identifying one or more risks from the one or more identified issues at the sites, studies, or customer portfolios by one or more clinical leads, wherein the one or more clinical leads identify a cause for the one or more identified risks among statistical composite risks, investigator risks, monitoring risks, audit/inspection likelihood and/or recruitment risks;
identifying mitigation actions for the one or more identified risks by using insights from past performance to identify the mitigation actions that will address the one or more identified risks; and
applying the mitigation actions onto the one or more identified risks from the sites, studies and/or customer portfolios.

2. The computing device implemented method of claim 1, further comprising:
providing snapshots of issues at countries, regions, and/or investigators in real-time.

3. The computing device implemented method of claim 1, further comprising:
identifying measurement data and/or metrics from the one or more identified risks of the sites, studies and/or customer portfolios.

4. The computing device implemented method of claim 1, further comprising:
performing an efficiency assessment of the mitigation actions to identify the mitigation actions to address the one or more identified risks.

5. The computing device implemented method of claim 1, wherein historical data is used to identify one or more of the mitigation actions that are most effective against the one or more identified risks.

6. The computing device implemented method of claim 1, further comprising:
identifying which of the mitigation actions is most effective in addressing the one or more identified risks.

7. The computing device implemented method of claim 1, further comprising:
obtaining current data metrics to show to one or more customers that request access to the current date metrics.

8. A computer program product comprising a tangible storage medium encoded with processor-readable instructions that, when executed by one or more processors, enable the computer program product to:
train an artificial intelligence/machine learning system to identify one or more issues at sites, studies, or customer portfolios;
apply the trained artificial intelligence/machine learning system to identify the one or more issues at the sites, studies or customer portfolios;
identify one or more risks from the one or more identified issues at the sites, studies, or customer portfolios by one or more clinical leads, wherein the one or more clinical leads identify a cause for the one or more identified risks among statistical composite risks, investigator risks, monitoring risks, and/or recruitment risks;
identify mitigation actions for the one or more identified risks by using insights from past performance to identify the mitigation actions that will address the one or more identified risks; and
apply the mitigation actions onto the one or more identified risks from the sites, studies and/or customer portfolios.

9. The computer program product of claim 8, wherein data is aggregated by study, customer, and/or region.

10. The computer program product of claim 8, wherein the snapshots of the issues at the sites, studies, or customer portfolios provide a real-time overview of operational performance.

11. The computer program product of claim 8, wherein the site monitoring includes monitoring one or more tasks that need to be performed.

12. The computer program product of claim 8, wherein the snapshots of the issues also occur at regions, countries, and/or individual investigators.

13. The computer program product of claim 8, wherein information on performance of the sites, studies, and/or customer portfolios are obtained from the snapshots of the issues.

14. The computer program product of claim 8, wherein workflows in relation to mitigation of the one or more risks are created in response to the one or more identified risks.

15. A computing system connected to a network, the system comprising:
one or more processors configured to:
train an artificial intelligence/machine learning system to identify one or more issues at sites, studies, or customer portfolios;
apply the trained artificial intelligence/machine learning system to identify the one or more issues at sites, studies or customer portfolios;
identify one or more risks from the one or more identified issues at the sites, studies, or customer portfolios by one or more clinical leads, wherein one or more clinical leads identify a cause for the one or more identified risks among statistical composite risks, investigator risks, monitoring risks, and/or recruitment risks;
identify mitigation actions for the one or more identified risks by using insights from past performance to identify the mitigation actions that will address the one or more identified risks; and
apply the mitigation actions onto the one or more identified risks from the sites, studies and/or customer portfolios.

16. The computing system of claim 15, wherein an effectiveness of the identified mitigation actions are identified.

17. The computing system of claim 15, the identified mitigation actions are matched with the one or more risks based on an effectiveness of the identified mitigation actions.

18. The computing system of claim 15, wherein historical data of the mitigation actions is identified to match the mitigation actions with the one or more identified risks.

19. The computing system of claim 15, wherein one or more other risks to occur at a future time interval at the sites, studies, or customer portfolios are identified.

20. The computing system of claim 15, wherein leading indicators of the one or more identified risks are determined.
